(19) United States
(12) Patent Application Publication
(10) Pub. No.: US 2025/0288397 A1
(43) Pub. Date: Sep. 18, 2025

(54) DENTAL PROSTHETIC DEVICE

(71) Applicant: Luigi GARGIULO, Boscoreale (IT)

(72) Inventor: Luigi GARGIULO, Boscoreale (IT)

(21) Appl. No.: 18/861,391

(22) PCT Filed: Apr. 30, 2023
(86) PCT No.: PCT/IT2023/050114

§ 371 Date: Oct. 29, 2024

(30) Foreign Application Priority Data
May 3, 2022 (IT) 102022000008984

(51) Int. Cl. A61C 8/00

(52) U.S. Cl. CPC A61C 8/006; A61C 8/0063; A61C 8/0068

(57) ABSTRACT

A dental prosthetic device (1) is described, designed for the creation of at least one prosthetic product, that can be customized by the operator according to the patient's clinical needs, that comprises at least a rotating element (20), connected at the bottom with an implant element (5) by means of an anchoring means (10) and at the top with the stump tooth (4) by means of a connection (3), this rotating element (20), being made up of an upper portion (21) and a lower portion (22). This upper portion (21) of the rotating element (20) being arranged with respect to the lower portion (22) as a function of the value assumed by the angle α.

The present invention about a dental prosthetic device in particular a dental implantology prosthetic device.

Implants for locking dental prostheses are known which comprise an endosseous portion provided with an external thread designed to be screwed into the bone seat of the teeth, as well as an abutment designed to be fixed to the endosseous portion and used for anchoring the dental prosthesis

To allow the coupling to be obtained, the abutment comprises a graft appendage able to be inserted into a corresponding graft recess formed in the endosseous portion.

In order to stably fix the abutment to the endosseous portion, axially hollow abutments are used to allow the insertion of a screw which is screwed into the internally threaded recess provided in the endosseous portion.

It is also known in the art according to which the abutment is fixed to the endosseous portion by means of a cementing process, which however does not avoid the risk of possible infiltrations and additionally can cause some drawbacks, for example the cement could detach.

Implants are also known in which the abutment comprises a graft appendix able to engage in a corresponding graft cavity made in the endosseous portion, in which the graft appendix, for example, is threaded so as to be able to be screwed into the cavity correspondingly threaded made in the endosseous portion.

Other improved joining methods are known such as, for example, particular configurations of the abutment attachment appendages and of the recess created in the endosseous portion For example, endosseous portions are known provided with an annular cavity on the opening of the recess, the cavity being suitable for the axial insertion of a corresponding annular projection present on the appendage of the abutment.

It is also known in the dental technique that the insertion of the dental implant in the bone arch can assume an inclination of up to 30° with respect to the final position of the prosthesis, causing undercuts. Development studies are known to seek solutions relating to the elimination of undercuts from the preparations of teeth to be prosthetic! zed, as well as allowing the creation of a precise artifact and obtaining a suitable insertion axis especially in the case of multiple abutments, necessary during the taking of the impression to reduce the stresses to which the material is subjected during the phase of removal from the oral cavity, to make the undercuts immediately visible, CAD programs are known which serve to virtually identify the undercuts, i.e. the convexity of a tooth with respect to the horizontal plane to a selected intersection axis, but this virtual design does not simultaneously guarantee parallelism with respect to the abutment and the prosthetic work.

It is evident that there is no dental device that guarantees the parallelism and alignment of the abutment in the prosthetic product, eliminating the undercuts of each abutment in the realization of the prosthetic product.

The object of the present invention is to solve the aforementioned problems of the prior art by providing a dental prosthetic device for making at least one prosthetic product which can be customized by the operator according to the patient's clinical needs.

Another object of the present invention is to provide a device capable of optimizing the positioning of a dental abutment of a dental prosthetic item by ensuring correct alignment and parallelism of the abutment in the prosthetic item, eliminating the formation of any undercuts.

The above and other objects and advantages of the invention, as will appear from the following description, are achieved with a dental prosthetic device such as the one described in claim 1. Preferred embodiments and non-trivial variants of the present invention form the object of the dependent claims.

It is understood that all the attached claims form an integral part of the present description. It will be immediately obvious that innumerable variations and modifications can be made to what has been described (for example relating to shape, dimensions, arrangements and parts with equivalent functions) without departing from the scope of protection of the invention as appears from the attached claims.

The present invention will be better described by some preferred embodiments, provided by way of non-limiting example, with reference to the attached drawings, in which:

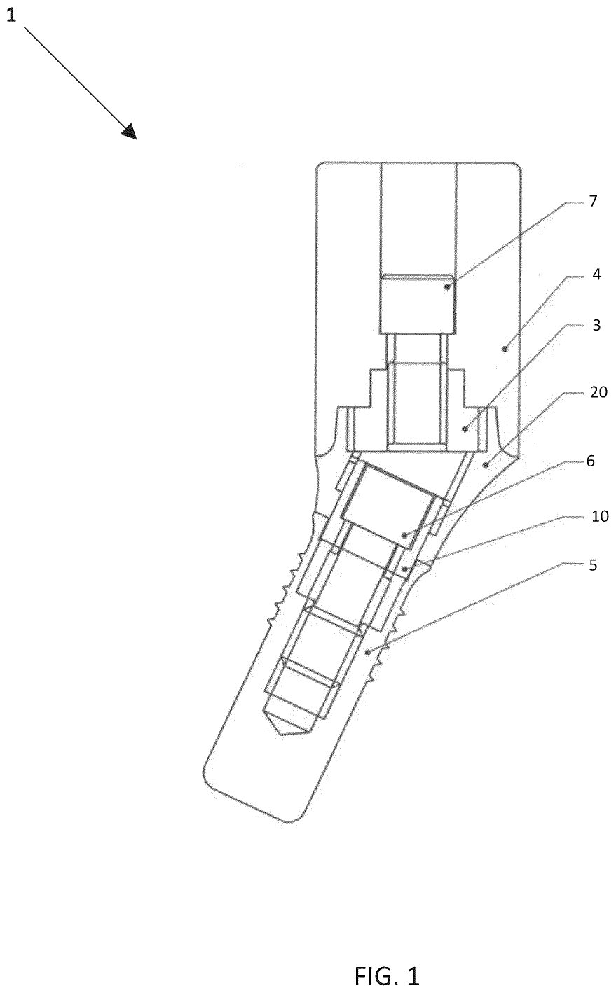

FIG. 1 shows a sectional view of a preferred embodiment of the device according to the present invention;

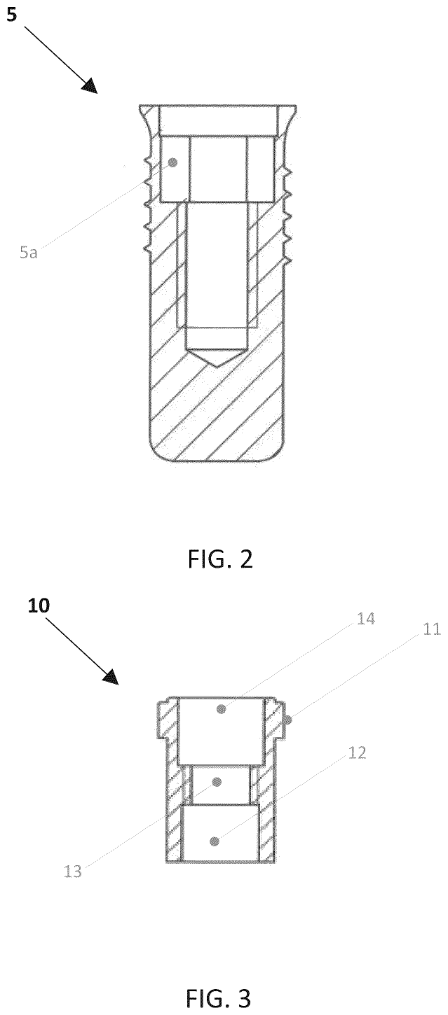

FIG. 2 shows a sectional view of an element of the device according to the present invention;

FIG. 3 shows a sectional view of an element of the device according to the present invention;

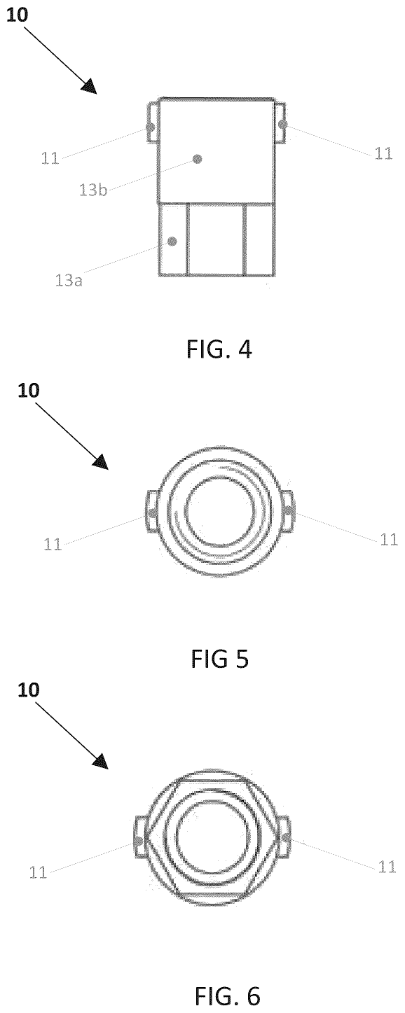

FIG. 4 shows a side view of an element of the device according to the present invention;

FIG. 5 shows a top plan view of an element of the device according to the present invention;

FIG. 6 shows a bottom plan view of an element of the device according to the present invention;

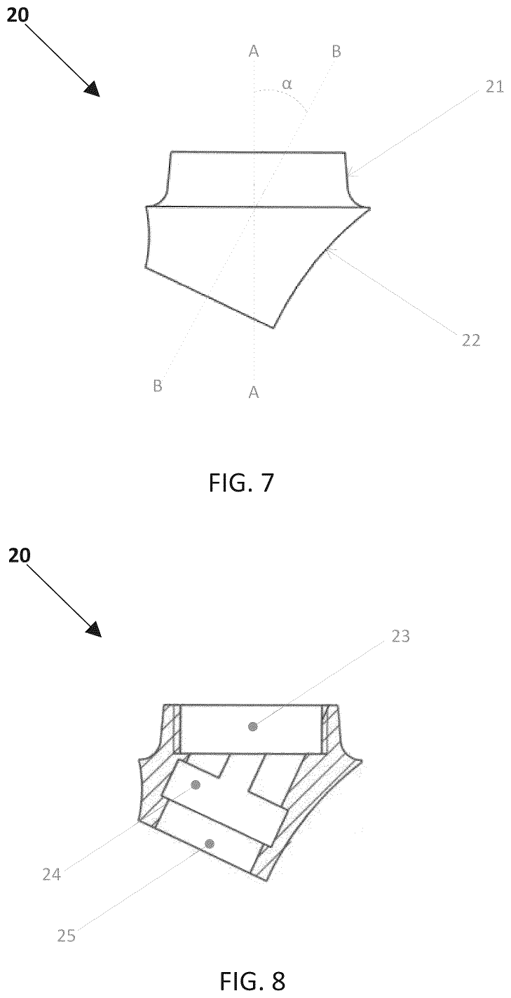

FIG. 7 shows a side view of an element of the device according to the present invention;

FIG. 8 shows a sectional view of an element of the device according to the present invention;

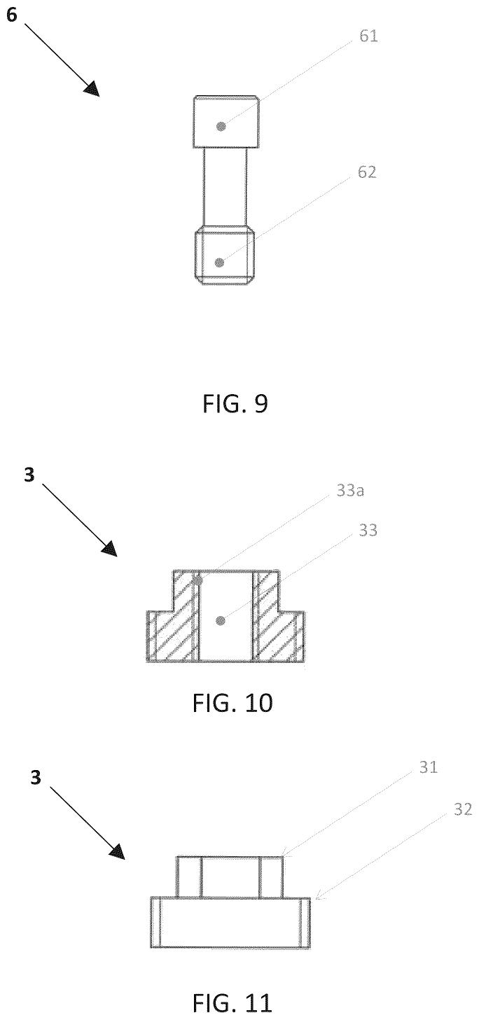

FIG. 9 shows a side view of an element of the device according to the present invention;

FIG. 10 shows a sectional view of one means of the device according to the present invention;

FIG. 11 shows a side view of one means of the device according to the present invention;

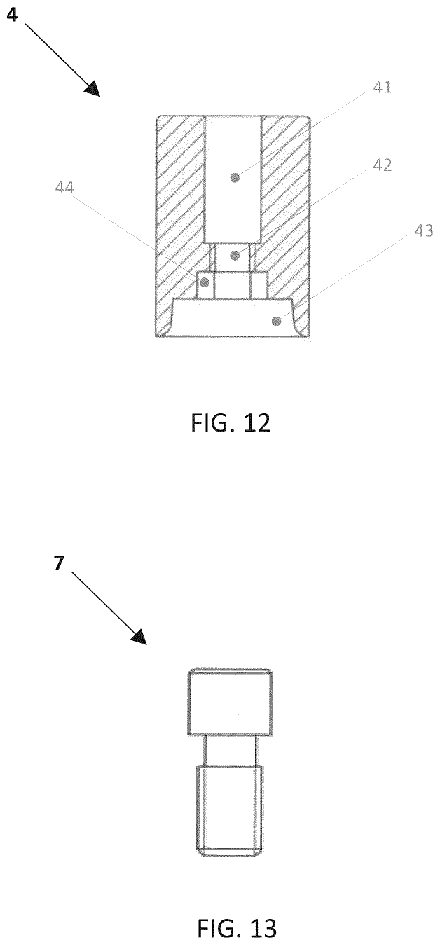

FIG. 12 shows a sectional view of an element of the device according to the present invention;

FIG. 13 shows a side view of an element of the device according to the present invention; And

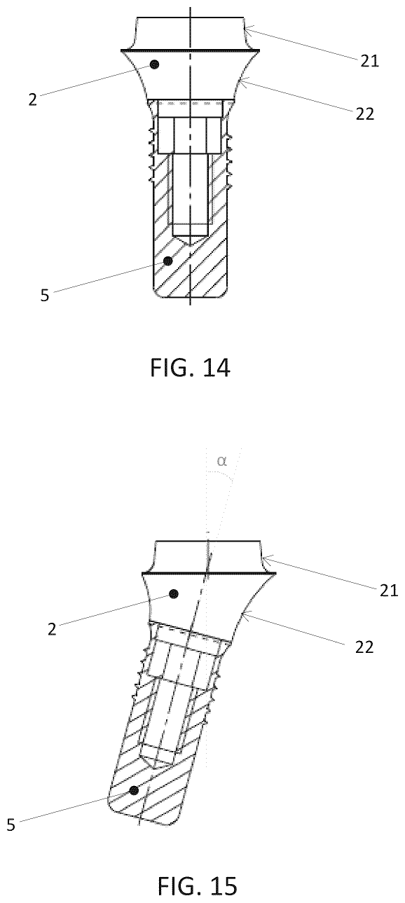

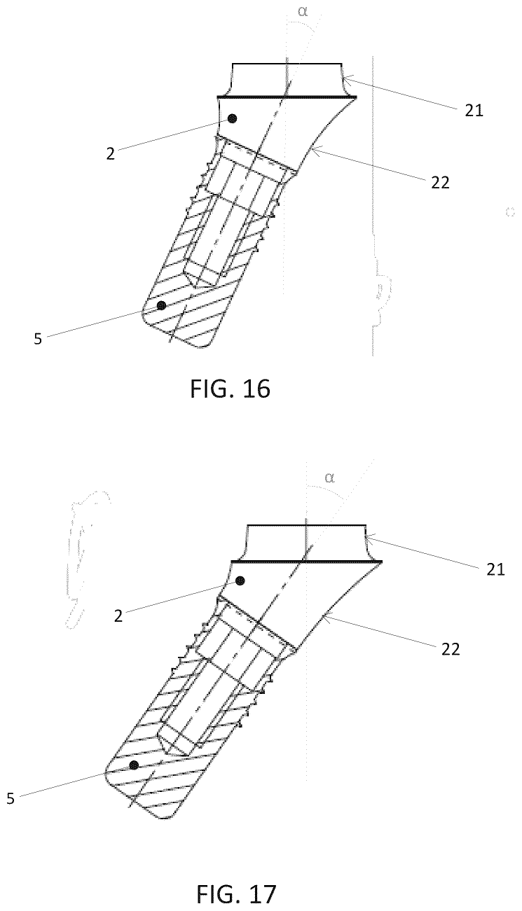

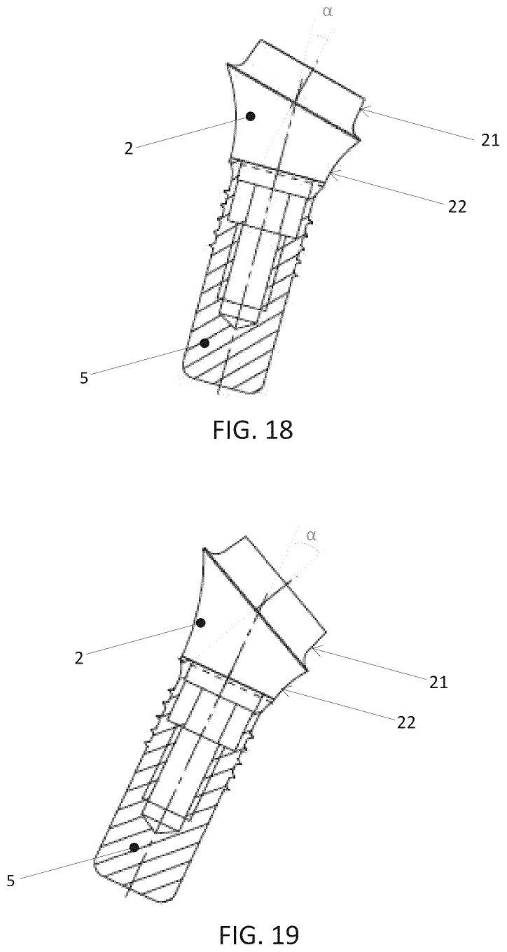

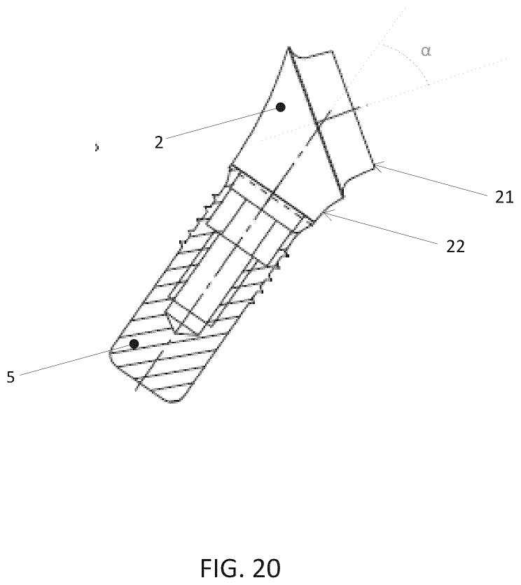

FIGS. 14-20 show a sectional view of embodiments of the device according to the present invention.

Referring to FIG., a dental prosthetic device 1, according to the present invention, designed for making at least one prosthetic item which can be customized by the operator according to the patient's clinical needs, optimizing the positioning of at least one dental abutment 4, eliminating any undercuts produced in the prosthetic making, and guaranteeing the alignment of the abutment 4 in the prosthetic product, includes:
at least one implant element 5, designed to be implanted in the bone site below the gum, by means of an external thread arranged on the external surface of the implant element 5, and connected at the top with at least one anchoring means 10, equipped in the upper portion with a chamber upper centering and closing 5a of conical or cylindrical shape, designed for centering and closing an anchoring means 10;
the anchoring means 10, coupled at the bottom with the implant element 5 and at the top with a rotating element 20; and provided above on the external surface with two or more anchoring tabs 11, intimately connected with the upper portion 13b, by means of chemical or mechanical fixing, for example a bayonet or other similar, or both fixings, with the internal surface of a first and a second cavity 24, 25 of the rotating element 20, allowing rotation of the rotating element 20 with respect to the anchoring means 10 by an angle γ with γ between 0° and 360°, allowing to adapt to the gingival profile and at the same time ensure the alignment of the abutment 4 in the prosthetic product;
the rotating element 20, connected at the bottom with the implant element 5 by means of the anchoring means 10 and at the top with at least one abutment 4 by means of a connection means 3;
the connection means 3, designed to connect the abutment 4 to the rotating element 20;
the abutment 4, connected to the rotating element 20 by means of connection means 3 and designed to fix a dental prosthesis integral with the abutment 4 by means of a chemical fixing, a mechanical fixing or both by inserting a through screw 7;
a first through screw 6, designed to tighten the rotating element 20 with the implant element 5 by means of the anchoring means 10; And
a second through screw 7, designed to tighten the abutment 4 with the rotating element 20 by means of the coupling means 3.

The rotating element 20 consists of:
an upper portion 21 externally equipped with a conical profile to facilitate the coupling of the abutment 4 with the rotating element 20, and equipped with a first axis of symmetry A; And
a lower portion 22, equipped with a second axis of symmetry B; advantageously the intersection of the first axis of symmetry A with the second axis of symmetry B constitutes an angle α, with a between 0° and 60°. Also upper portion (21) of rotating element (20) being arranged with respect to lower portion (22) as a function of the value assumed by the angle α.

As shown in FIGS. 15-20, depending on the value assumed by the angle α obtained from the intersection of the first axis of symmetry A with the second axis of symmetry B, the lower portion 22 of the rotating element 20 assumes a shape and a physical dimension customizable by the operator according to the clinical needs of the patient according to the value assumed by the angle α, allowing to physically obtain a rotating element 20 with physical shape and size capable of compensating the inclination of the implant element 5 implanted in the bone site providing correct alignment of the abutment 4 in the prosthetic product, ensuring its parallelism with adjacent abutments or teeth.

As shown in FIGS. 15-17, as a function of the value assumed by the angle α obtained from the intersection of the first axis of symmetry A with the second axis of symmetry B, the upper portion 21 of the rotating element 20 is arranged with respect to the lower portion 22 and at the same time the lower portion 22 of the rotating element 20 assumes a shape and a physical dimension customizable by the operator according to the patient's clinical needs according to the value assumed by the angle α, these upper portion 21 and lower portion 22 form the rotating element 20, integrally shaped, with a shape and physical size capable of compensating for the inclination of the implant element 5 implanted in the bone site providing correct alignment of the abutment 4 in the prosthetic product, ensuring its parallelism with adjacent abutments or teeth. Additionally, during the installation of the prosthetic product in the patient, once the rotating element 20 is coupled to the implant element 5, the rotating element 20 is designed to rotate by an angle γ with γ between 0° and 360°, with respect to the means of anchor 10, allowing the operator, during the installation of the prosthetic item, the optimal positioning of the abutment 4, contributing to the correct alignment and parallelism of the abutment 4 in the prosthetic item.

Additionally, the rotating element 20 is internally equipped with:
in the upper portion of a third cavity 23, designed to connect the connection means 3 with the rotating element;
in the central portion of the first cavity 24, equipped with grooves for housing the two or more anchoring fins 11 of the anchoring means 10, favoring the rotation of the rotating element 20 with respect to the anchoring means 10 of the angle γ with γ between 0° and 360°; And in the lower portion of the second cavity 25 internally equipped with a recess which allows the sliding and positioning of the anchoring means 10, favoring its rotation along the central axis. Advantageously, the anchoring means 10 is internally equipped with:
in the upper portion of a fourth cavity 14 of cylindrical or conical shape designed to facilitate the accommodation of the first head 61 of the first through screw 6, by mechanical fastening with expansion of grooved protrusions, or chemical fastening, or both fastenings;
in the central portion of a passage thread 13 designed to facilitate the passage and tightening of the first through screw 6;
in the lower portion of a fifth cylindrical cavity 12 designed for the passage of the threaded stem 62 of the first through screw 6;
the lower external portion 13a having a hexagonal, conical or other shape suitable for coupling with the upper centering and closing chamber 5a of the implant element 5, favoring its optimal positioning in a unique and repeatable way; And
the upper external portion 13b of cylindrical shape, or other suitable, designed to mate with the first and second cavities 24, 25 of the rotating element 20 allowing advantageously the centering of the rotating element 20 with the implant element 5.

Additionally, the connecting means 3 consists of a third upper portion 31 of a cylindrical, hexagonal, conical or other shape suitable for coupling with the abutment 4; a fourth lower portion 32 provided on the outer surface with a thread or bayonet fitting; a fifth central portion 33 equipped on the internal surface with a thread 33a designed to facilitate the passage and tightening of the second through screw 7, preferably the fifth central portion 33 is equipped with a conical attachment with grooves or bayonet.

Besides, abutment 4 consists internally of:
a sixth upper portion 41 of any geometrical shape designed to house the head of the second through screw 7;
a seventh central portion 42 as a threaded axial recess designed for the passage of the threaded stem of the second through screw 7;
an eighth lower portion 43 having a profile shape corresponding to the shape of the outer profile of the upper portion 21 of the rotating element 20; And
a ninth portion 44 with a hexagonal shape or other geometric shape designed to intimately couple with the third upper portion 31 of the connection means 3 ensuring the unique and repeatable positioning of the abutment 4.

Some preferred embodiments of the invention have been described, but naturally they are susceptible to further modifications and variations within the same inventive idea. In particular, numerous variants and modifications, functionally equivalent to the previous ones, which fall within the scope of protection of the invention as highlighted in the attached claims, will be immediately evident to those skilled in the art.

1. Dental prosthetic device (1) designed for the creation of at least one prosthetic product, that can be customized by the operator according to the patient's clinical needs, comprising at least a rotating element (20), connected at the bottom with an implant element (5) by means of an anchoring means (10) and at the top with the stump tooth (4) by means of a connection (3), the rotating element (20), being made up of:
an upper portion (21) externally equipped with a conical profile to facilitate the coupling of the stump tooth (4) with the rotating element (20), and equipped with a first axis of symmetry A;
a lower portion (22), equipped with a second axis of symmetry B, the intersection of the first axis of symmetry A with the second axis of symmetry B constitutes an angle α, with a between 0° and 60° giving a the lower portion (22) of the rotating element (20) a physical shape and size according to the value assumed by the angle α capable of compensating the inclination of the implant element (5) implanted in the bone site providing correct alignment of the stump tooth (4) in the prosthetic product; the upper portion (21) of the rotating element (20) being arranged with respect to the lower portion (22) as a function of the value assumed by the angle α.

2. The device (1) according to claim 1, wherein the rotating element (20) is equipped internally:
in the upper portion of a third cavity (23), designed to connect the connecting means (3) with the rotating element (20);
in the central portion of a first cavity (24) designed to prevent translation along the axis and favor the rotation of the rotating element (20) with respect to the anchoring means (10) by an angle γ with γ between 0° and 360°; and
in the lower portion of a second cavity (25) internally equipped with a recess that allows the sliding and positioning of the anchoring means (10) favoring its rotation along the central axis.

3. The device (1) according to claim 1, wherein the rotating element (20) is designed to rotate by an angle γ with respect to the anchoring means (10), with the angle γ comprised between 0° and 360°, ensuring the optimal positioning of the stump tooth (4) connected to it.

4. The device (1) according to claim 1, wherein it further comprises a first passing screw (6), designed to tighten the rotating element (20) with the implant element (5) by means of the anchoring means (10), the first passing screw (6) is a variable expansion screw.

5. Device (1) according to claim 1, characterized in that it further comprises:
the implant element (5), designed to be implanted in the bone site below the gingiva, by means of an external thread arranged on the external surface of the implant element (5), and connected at the top with the anchoring means (10), provided in the portion upper of an upper centering and closing chamber (5a), designed for centering and closing the anchoring means (10);
the anchoring means (10), coupled below with the implant element (5) and above with the rotating element (20); and equipped at the top on the external surface with two or more anchoring fins (11), intimately connected by chemical or mechanical fixing, or both fixings, with the internal surface of the first and second cavities (24), (25) of the rotating element (20), allowing a rotation of the rotating element (20) with respect to the anchoring means (10) by the angle γ with γ comprised between 00 and 3600;
the connecting means (3), designed to connect the stump tooth (4) to the rotating element (20);
the stump tooth (4), connected to the rotating element (20) by means of the connection means (3) and designed to fix a dental prosthesis by means of a thread or bayonet connection arranged on the external surface of the stump tooth (4);
a second through screw (7), designed to tighten the stump tooth (4) with the rotating element (20) by means of the coupling means (3).

6. The device (1) according to claim 5, wherein the anchoring means (10) is internally equipped:
in the upper portion of a fourth cavity (14) cylindrical or conical in shape designed to favor the accommodation of the first head (61) of the first through screw (6);
in the central portion of a passage thread (13) designed to facilitate the passage and tightening of the first through screw (6); and
in the lower portion of a fifth cylindrical-shaped cavity (12) designed for the passage of the shank of the first through screw (6);
a lower external portion (13a) designed to couple in the chamber (5a) of the implant element (5) favoring its optimal positioning in a repeatable way; and
an upper external portion (13b), designed to couple with the first and second cavities (24), (25) of the rotating element (20) advantageously allowing the centering of the rotating element (20) with the implant element (5).

7. The device (1) according to claim 4, wherein the connecting means (3) consists of a third upper portion (31); a fourth lower portion (32) provided on the external surface with a thread or bayonet coupling; a fifth central portion (33) equipped on the internal surface with a thread (33a) designed to facilitate the passage and tightening of the second through screw (7).

8. The device (1) according to claim 4, wherein the stump tooth (4) consists internally of:
a sixth upper portion (41) designed to house the head of the second through screw (7);
a seventh central portion (42) designed for the passage of the threaded shank of the the second through screw (7);
an eighth lower portion (43) having the shape of the profile corresponding to the shape of the external profile of the upper portion (21) of the rotating element (20);
a ninth portion (44) of hexagonal shape or another geometric shape designed to closely couple with the third upper portion (31) of the connection means (3) ensuring the unique and repeatable positioning of the stump tooth (4).
